(19) United States
(12) Patent Application Publication
(10) Pub. No.: US 2002/0106236 A1
(43) Pub. Date: Aug. 8, 2002

(54) Binder insert

(76) Inventor: Yukari Hashizume, Osaka (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 10/037,728

(22) Filed: Oct. 19, 2001

(30) Foreign Application Priority Data
Oct. 20, 2000 (JP) 2000-320951

(51) Int. Cl. B42F 13/00

(52) U.S. Cl. 402/79

(57) ABSTRACT

The present invention has an object to provide a binder insert enabling a photograph to be mounted without using adhesive and the like and to write memos as needs arise. The binder insert is comprised of a plastic body and having a bag shape with the upper side thereof opened, a photograph store portion and a memo store portion are provided by dividing the body at a melt portion, a store board, which is made by folding a thick paper in two, having slits at predetermined positions thereof to insert corners of a photograph and a color paper therebetween, and a memo paper to be inserted into a memo store portion. At one side of the body, a binding section having a plurality of binding holes is provided. Slits provided within the store board are a set consisting of four pieces and plural sets are positioned in accordance with standardized photograph sizes for insertion of corners of a photograph. A form of each slit is curved, and round holes are provided at both ends of said curved slits. Color print portions having different colors in accordance with the standardized photograph sizes are provided in the color paper at corresponding positions of slits provided within the store board.

### FIELD OF THE INVENTION

The present invention relates to a binder insert, whereby photographs can be mounted without using adhesive and the like, and also memos can be written easily.

### DESCRIPTION OF THE PRIOR ART

According to a conventional album, a photograph is mounted on a bound binder insert by using adhesive and the like, or by attaching triangular corner-supports to each corner thereof, back surfaces of which are applied with adhesive and the like. As examples of non-adhesive binder inserts, a binder insert having several photograph-sized pockets formed by dividing a transparent bag or a binder insert covered with a transparent film for storing photographs in each pocket, and a binder insert applied with nondrying adhesive and covered with a transparent plastic film for storing a photograph between the binder insert and the film having been already known.

With a conventional album using adhesive and the like, it may be difficult to peel off or replace a photograph after it has been mounted. Also, degradation of adhesives can advance as time passes, which can affect photographs.

On the other hand, a non-adhesive pocket binder insert as called does not allow a free layout since a photograph store portion thereof is procrustean and also has a problem of lack of luxuriousness. While a binder insert using nondrying adhesive allows a free layout, a problem is pointed out that long-term usage of adhesive brings deterioration of the adhesive or a fear that a photograph may cling to a transparent film.

In view of the above situation, an object of the present invention is to provide a binder insert which allows a photograph to be mounted without adhesive and the like and provides a means for memo writing as needed.

### SUMMARY OF THE INVENTION

To achieve the above object, the present invention provides a binder insert comprising a body which is made of transparent plastic material and has a bag shape with the upper side thereof opened, a photograph store portion and a memo store portion formed by dividing the body at a melt portion, a store board which is made by folding a thick board in two, the store board having slits at predetermined portions to insert corners of a photograph and having a color paper therebetween, and a memo paper to be inserted into the memo store portion.

A means for providing a binding section having a plurality of binding holes at one side of the body is further adopted.

Specifically, a plurality of sets of slits in four pieces capable to store corners of a photograph are positioned in accordance with standardized photograph sizes in the store board.

A binder insert having the above structure enables one to lay out photographs without using adhesives and the like and facilitates removing or replacing a photograph as a photograph is to be mounted by inserting corners thereof into a selected set of slits corresponding to a size of the photograph.

A binder insert having curved slits with round holes provided at both ends of the slits is also provided.

A curved slit facilitates inserting corners of a photograph by pulling up thereof in tongue shape. Also, round holes in both ends of a curved slit prevent the slit from slitting open.

A means for providing color print portions having different colors according to the standardized photograph sizes at corresponding positions of slits provided within the store board is also described.

In this case, the color print portions can be seen through the slits and the corresponding relationship of each slit may be easily identified since different colors are printed according to standardized photograph sizes.

In accordance with the present invention, the slits provided on the store board can assume various forms. Specific mention can be made of plural lines of upward U-shaped slits and plural lines of downward U-shaped slits arranged by turn, a plurality of perforation slits arranged in a form of lozenge, a plurality of perforation slits arranged in a form of a whirl, and a plurality of wave perforation slits arranged in a plurality of rows.

In these cases, a photograph can be supported by inserting the upper side and the lower side thereof or corners thereof into a selected slit at a suitable position in accordance with the size of the photograph.

### BRIEF DESCRIPTION OF THE DRAWINGS

FIG. 1 is a front view of a binder insert in accordance with one embodiment of the present invention;

FIG. 2 is a front view of the binder insert of FIG. 1 showing a state that a store board and a memo paper are pulled to a middle point;

FIG. 3 is an explanatory view illustrating a binder insert in accordance with the present invention wherein a color paper is located between a store board;

FIG. 4 is a front view showing another form of a slit in accordance with the present invention;

FIG. 5A illustrates a binder insert having service sized photographs mounted thereon;

FIG. 5B illustrates a binder insert having panorama sized photographs mounted thereon;

FIG. 6A illustrates a binder insert having post card sized photographs mounted thereon;

FIG. 6B illustrates a binder insert having cabinet sized photographs mounted thereon;

FIG. 7 is a front view showing another embodiment of the present invention illustrating another example of a color print portion of a color paper;

FIG. 8A is a front view of a binder insert in accordance with the present invention illustrating a third configuration of slits;

FIG. 8B is a front view of a binder insert in accordance with the present invention illustrating a fourth configuration of slits;

FIG. 9A is a front view of a binder insert in accordance with the present invention illustrating a fifth configuration of slits; and

FIG. 9B is a front view of a binder insert in accordance with the present invention illustrating a sixth configuration of slits.

### DETAILED DESCRIPTION OF THE PREFERRED EMBODIMENT

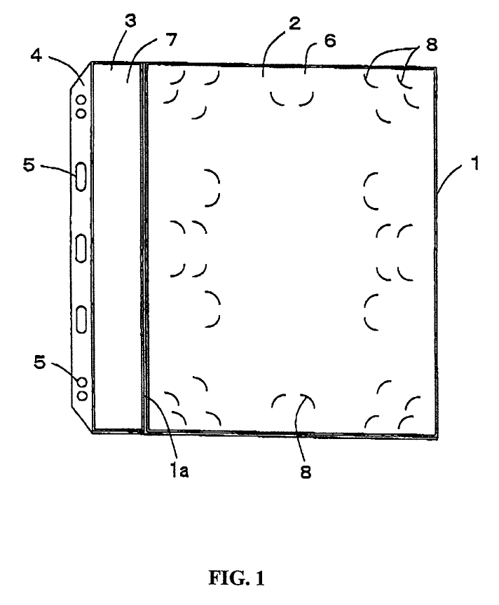

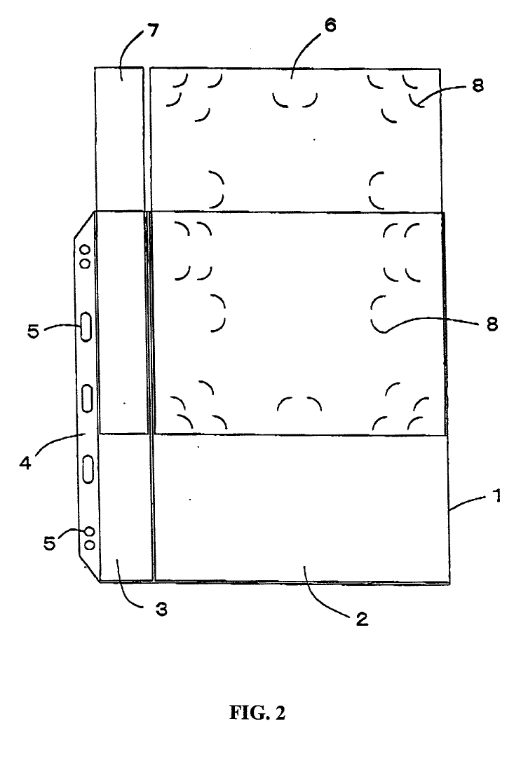

Hereinafter, a preferred embodiment of a binder insert in accordance with the present invention is discussed with reference to the drawings. FIG. 1 and FIG. 2 are perspective views showing one example of a binder insert in accordance with the present invention. As shown in FIGS. 1 and 2, the binder insert includes a body 1 made of a transparent film and being bag-shaped with the upper side thereof opened. Body 1 is divided into a photograph store portion 2 of relatively broad width and a memo store portion 3 of relatively narrow width at a melt portion 1a. A binding section 4 is provided at one side of the body 1, wherein a plurality of binding holes 5 at regular intervals are provided for the body 1 to be bound in a binder and the like.

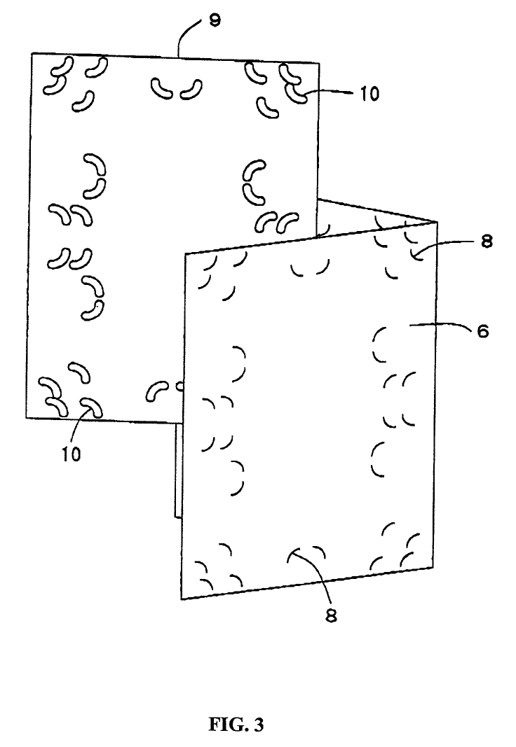

As shown in FIG. 2, a store board 6 is inserted into the photograph store portion 2 in body 1 and a memo paper 7 is inserted into the memo store portion 3. The store board 6 made by folding a thick paper in two, has a plurality of slits 8 at predetermined positions of each surface thereof for insertion of corners of a photograph and has a color paper therebetween as shown in FIG. 3.

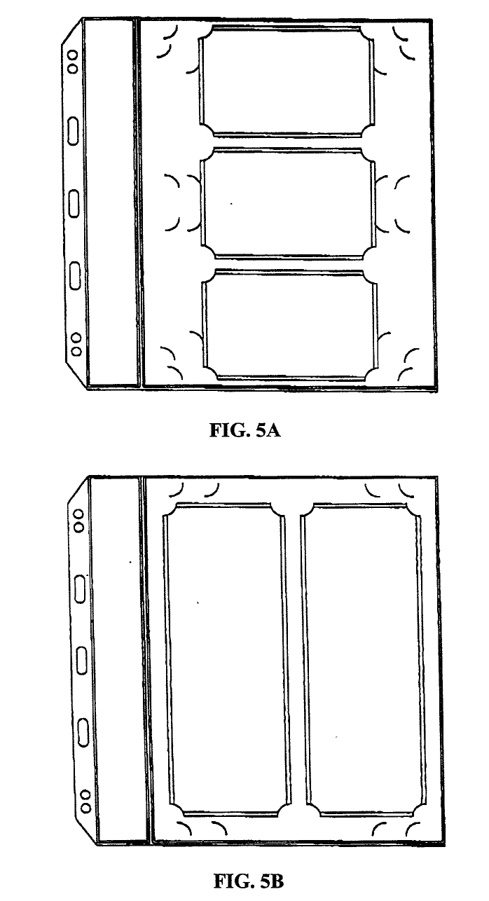

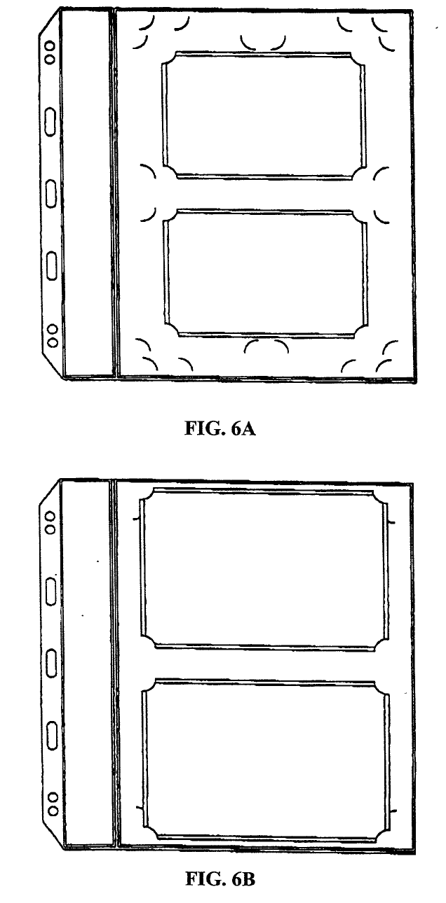

The slits 8 are in a set of four pieces provided at suitable positions for inserting and supporting corners of each photograph of standardized size such as a service size (E·L 89 mm×129 mm), a post card size (K·G 102 mm×148 mm), a cabinet size (2L 130 mm×180 mm), and a panorama size (89 mm×254 MM). For example, FIG. 5A shows a state that three service sized photographs are inserted and FIG. 5B shows a state that two panorama sized photographs are inserted. FIG. 6A shows a state that two post card sized photographs are inserted and FIG. 6B shows a state that two cabinet sized photographs are inserted. Every set of slits 8 is provided within one store board 6 to be applicable to each sized photograph.

The position of each of the slits 8 is not limited to the foresaid positions. For example, since a different standard size is adopted in an APS standardized photograph, the slits may be positioned to accommodate that size.

The form of the slits 8 is not particularly limited. While slits may be provided in the form of a straight line, curved slits as shown in FIG. 1 facilitate inserting corners of a photograph since the slits portion can be lifted. Moreover, providing round holes 8a at both ends of each of the slits 8 prevents the slits 8 from slitting open to an extending direction and facilitates to insert corners of a photograph.

The color paper 9 shown in FIG. 3 has curved color print portions 10 on both surfaces thereof in line with each position of the slits 8 provided within the store board 6. The color print portions 10 are provided by printing different colors according to the various photograph sizes on both surfaces of the color paper 9. For example, in accordance with one embodiment, red is for a service size, green is for a post card size, blue is for a cabinet size, and yellow is for a panorama size. With the color paper 9 placed between the store board 6, the color portions 10 can be seen through the slits 8 provided within the store board 6. The different colors assist in identifying the position of the slits 8 corresponding to a certain photograph size and facilitates inserting corners of the photograph. The color print portions also have an embellishing effect with colors studded on surfaces of the store board.

The color paper 9 provides an advantage in that it prevents contact between corners of photographs which may be caused inside of the store board 6 when photographs are inserted into both surfaces of the store board 6.

Photo records concerning each photograph inserted in the store board 6 can be freely written on the memo paper 7. Accordingly, the memo paper 7 may be left blank or have printed lines or frames on demand.

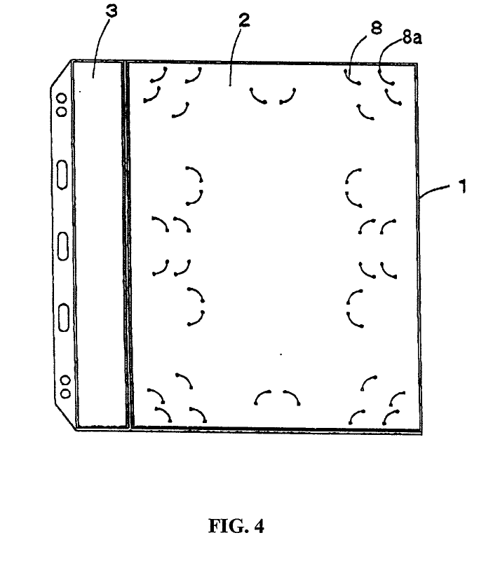

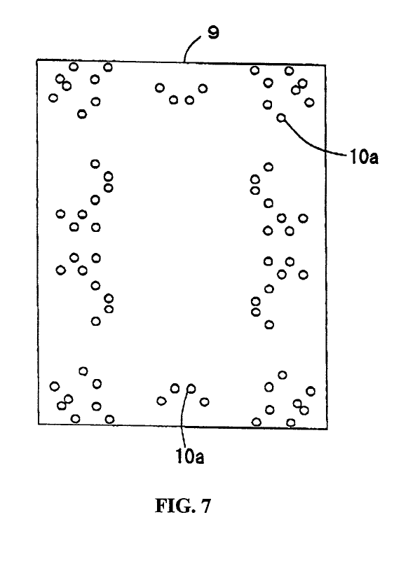

FIG. 7 illustrates another example of the color paper 9. Instead of curved color print portions 10 as shown in FIG. 3, round color print portions 10a are printed at positions corresponding with the round holes 8a provided in both ends of the slit 8 shown in FIG. 4. With different colors printed on the color print portion 10 a in accordance with each size of photographs, a correct set of the slits 8 for insertion of a photograph can be easily identified by the colors as seen through round holes 8a.

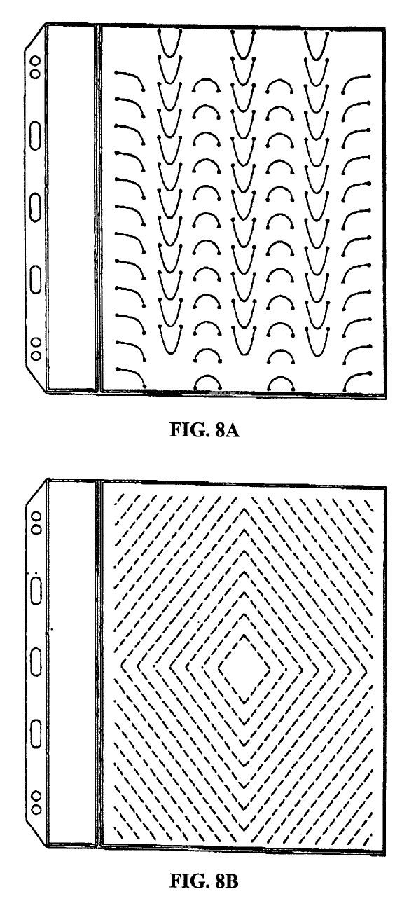

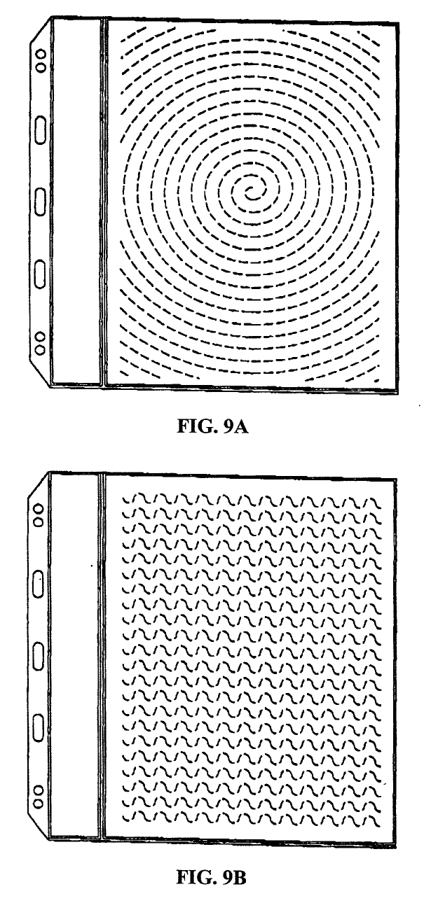

FIG. 8A and FIG. 9A illustrate embodiments of a binder insert in accordance with the present invention showing various forms of slits provided within the store board 6. In FIG. 8A, lines of upward U-shaped slits and lines of downward U-shaped slits are arranged by turns. A photograph is mounted by inserting the upper and lower sides thereof into suitable upward and downward slits in line with the size of the photograph.

In FIG. 8B, perforation slits are arranged forming multilayer lozenges. A photograph is mounted by inserting corners thereof into suitable perforation slits in line with the size of the photograph. With arrangement of the perforation slits discussed above, a user can freely select a point and lay out a photograph.

In FIG. 9A, perforation slits are arranged forming a whirl and in FIG. 9B, wave perforation slits are arranged in rows. In both cases, a photograph can be mounted by utilizing suitable perforation slits.

As discussed above, since a binder insert in accordance with the present invention has plurality sets of slits, which are positioned in accordance with standardized photograph sizes, provided within a store board insertable into a photograph store portion of a body, a photograph can be mounted by inserting corners thereof into suitable slits. Unlike a conventional binder insert, the present invention does not need adhesive and the like and therefore eliminates any degradation of a photograph which may result from deterioration of the adhesive with aging. Accordingly, an advantage in storing photographs long term is also expected.

Since the binder insert is a pocket type, a photograph can be easily mounted by sliding the store board out and mounting the photograph on the store board. Also, a photograph will be inside of a transparent plastic bag, thereby keeping the photograph in a good condition without exposing it directly to the air after storing, which indicates the binder insert is suitable for long-term storage.

While the present binder insert can be an album when bound alone, the binder insert can also be bound in a binder of increasable-decreasable size by providing a binding section at one side thereof.

The present binder insert is further suitable for long-term usage with curved slits and round holes provided at both ends of the slits facilitating insertion of corners of a photograph and preventing the slits from slitting open.

With color print portions of different colors according to standardized photograph sizes provided at positions where slits in the store board are located, corresponding relationship of each slit can be easily identified with the color print portions provided within the color paper through each slit. Therefore, a photograph can be easily mounted.

A memo paper is separately provided and therefore convenient to write a photo record and the like. Since the memo paper can be taken in and out, addition of a record or replacement is easily conducted. Also, the memo paper is suitable for long-term usage because the memo store portion prevents exposure to dirt.

When lines of upward and downward perforation slits arranged by turn or perforation slits in a form of multilayer lozenges are provided, the upper and lower sides or corners of a photograph can be inserted by selecting suitable slits. Also, when perforation slits in a form of whirls or a plurality of wave perforation slits in rows are provided, the upper and lower sides or corners of a photograph can be inserted by selecting suitable slits.

What is claimed is:

1. A binder insert comprising:
a transparent plastic body having a bag shape with an open upper side thereof;
a photograph store portion and a memo store portion provided by dividing said body at a melting point,
a store board, which is made by folding a thick paper in two, having slits at predetermined location thereof to insert corners of a photograph and a color paper therebetween; and
a memo paper to be inserted into said memo store portion.

2. A binder insert according to claim 1, further comprising a binding section having a plurality of binding holes.

3. A binder insert according to claim 1, wherein slits provided within said store board are a set consisting of four pieces and plural sets are positioned in accordance with standardized photograph sizes for insertion of corners of a photograph.

4. A binder insert according to claim 3, wherein a form of each of said slits is curved.

5. A binder insert according to claim 4, wherein round holes are provided at both ends of said curved slits.

6. A binder insert according to claim 3, wherein color print portions having different colors in accordance with said standardized photograph sizes are provided within said color paper at corresponding positions of slits provided within said store board.

7. A binder insert according to claim 1, wherein slits provided within a store board are upward U-shaped and downward U-shaped arranged in lines by turn.

8. A binder insert according to claim 1, wherein slits provided within a store board are perforations arranged in lozenges.

9. A binder insert according to claim 1, wherein slits provided within a store board are perforations in a form of whirls.

10. A binder insert according to claim 1, wherein slits provided within a store board are waved perforations arranged in a plurality of rows.

11. A binder insert according to claim 2, wherein slits provided within said store board are a set consisting of four pieces and plural sets are positioned in accordance with standardized photograph sizes for insertion of corners of a photograph.

12. A binder insert according to claim 5, wherein color print portions having different colors in accordance with said standardized photograph sizes are provided within said color paper at corresponding positions of slits provided within store board.

13. A binder insert according to claim 2, wherein slits provided within a store board are upward U-shaped and downward U-shaped arranged in lines by turn.

14. A binder insert according to claim 2, wherein slits provided within a store board are perforations arranged in lozenges.

15. A binder insert according to claim 2, wherein slits provided within a store board are perforations in a form of whirls.

16. A binder insert according to claim 2, wherein slits provided within a store board are waved perforations arranged in a plurality of rows.
